(19) United States
(12) Patent Application Publication
(10) Pub. No.: US 2022/0192413 A1
(43) Pub. Date: Jun. 23, 2022

(54) COFFEE PRESS FILTER

(71) Applicant: Xiaofeng LIU, Foshan City (CN)

(72) Inventor: Xiaofeng LIU, Foshan City (CN)

(21) Appl. No.: 17/152,740

(22) Filed: Jan. 19, 2021

(30) Foreign Application Priority Data
Dec. 17, 2020 (CN) 202023083017.8

(51) Int. Cl. A47J 31/06; A47J 31/44

(52) U.S. Cl. CPC A47J 31/0684; A47J 31/446

(57) ABSTRACT

The disclosure discloses a coffee press filter. The coffee press filter includes a filter pressing cylinder body, a filter pressing push rod and a filter pressing bracket, the filter pressing cylinder body is provided with a tubular water injection cavity, one end of the water injection cavity is an open end, the filter pressing bracket is internally provided with an accommodating cavity, the accommodating cavity is internally provided with a filtering cup, the other end, opposite to the open end, of the water injection cavity is integrally provided with a pressing cover, and the pressing cover is provided with a plurality of water outlets. The coffee press filter is integrally combined by this structure, thereby the original five spare and accessory parts are reduced to three spare and accessory parts, and the same function is achieved, a production cost may be reduced, and cleaning is easier after use.

### TECHNICAL FIELD

The disclosure relates to the field of coffee brewing devices, and in particular to a coffee press filter.

### BACKGROUND

A filter pressing coffee pot on the market generally adopts a filter pressing structure, namely coffee powder is poured into hot water, soaked and steamed, a pull rod is pressed after brewing time is reached, a coffee residue is filtered and coffee is poured out.

A Chinese patent document (authorized publication number: CN202981628U, authorized publication date: Jun. 12, 2013) discloses a coffee filter pressing device, the patent is capable of achieving coffee filtration by installing a single-use filter paper cover at a bottom portion of a filtering cylinder, a disadvantage thereof is that new filter paper needs to be replaced after it is used every time, so that a use cost of the filter pressing device is improved, resources are wasted, and the environment is polluted.

Therefore, the applicant applies for a reusable coffee press filter on Jun. 12, 2020. The coffee press filter does not need to use filter paper to filter coffee, and may be repeatedly used for many times after being cleaned. However, the coffee press filter in such a structure has more spare and accessory parts, therefore the coffee press filter needs to be further improved.

### SUMMARY

A purpose of the disclosure is to solve the above existing problem, and provide a coffee press filter in a simple and rational structure, a function thereof is that a part of spare and accessory parts is integrated and simplified, thereby the number of the spare and accessory parts of the coffee press filter is reduced.

The coffee press filter includes a filter pressing cylinder body, a filter pressing push rod and a filter pressing bracket detachably connected with the filter pressing cylinder body, the filter pressing cylinder body is provided with a tubular water injection cavity, one end of the water injection cavity is an open end, and the filter pressing push rod is pushed into the water injection cavity through the open end and is slid in a reciprocating type, the filter pressing bracket is internally provided with an accommodating cavity, the accommodating cavity is internally provided with a filtering cup, the other end, opposite to the open end, of the water injection cavity is integrally provided with a pressing cover, the pressing cover is enclosed with the filtering cup to form a brewing cavity, and the pressing cover is provided with a plurality of water outlets communicated with the brewing cavity and the water injection cavity.

The disclosure may also adopt the following technical measures to solve:

an integrated-type connection is formed by the filtering cup and the filter pressing bracket.

A cross sectional area of the water outlet is gradually decreased in a direction from the water injection cavity to the brewing cavity.

The pressing cover is integrally provided with a water injection column downwards extended to a portion close to a bottom portion of the brewing cavity, the water injection column is a tower-type structure and has a plurality of layers of ring-shaped step surfaces, and a peripheral edge of each layer of the ring-shaped step surface is provided with a plurality of central water outlets.

A liquid outlet clearance is installed between the filtering cup and an inner wall of the accommodating cavity, and a bottom portion of the accommodating cavity is provided with a liquid outlet communicated with the liquid outlet clearance.

A bottom surface of the accommodating cavity is slantwise installed from an external edge to a center, the liquid outlet is installed in a central position of the bottom surface, multiple radially extended flow guiding convex ribs are uniformly distributed on the bottom surface, and the flow guiding convex ribs are uniformly distributed along a circumferential direction of the liquid outlet and extended to the inner wall of the accommodating cavity.

The filtering cup includes a cup body, a metal filter cover and a pressing sleeve inner frame, a side wall and/or a bottom portion of the cup body is provided with a plurality of liquid discharge openings, the metal filter cover is installed in a cavity of the cup body and covers the liquid discharge openings, the metal filter cover is provided with multiple filtering small holes communicated with the brewing cavity, and the pressing sleeve inner frame is installed at a bottom portion of the metal filter cover.

A bottom portion of the filter pressing cylinder body is provided with a connecting sleeve nested on the filter pressing bracket, the connecting sleeve is provided with an inverted L-type fastening groove, an outer wall of the filter pressing bracket is provided with a fastening convex block corresponding to the fastening groove, and the filter pressing cylinder body is detachably connected with the filter pressing bracket through fastening cooperation.

An integrated fixed connection structure is formed by the filtering cup and the filter pressing bracket in modes of fastening, laser welding, integrated injection molding and bonding, the pressing cover and the filter pressing cylinder body are integrally formed by injection molding.

A circle of positioning convex ribs is extended on an outer end face, adjacent to a cup rim, of the filtering cup, the positioning convex ribs are sheathed with a sealing ring, and the sealing ring is sealingly pressed against a lower end face of the pressing cover.

A liquid loading vessel is further included, the coffee press filter is placed at an opening of the liquid loading vessel, and the filter pressing bracket is provided with at least one visible opening for observing a liquid level height of the liquid loading vessel.

The disclosure has the following beneficial effects.

The coffee press filter of the disclosure is simple in structure, and rational in design, the coffee press filter is integrally combined by this structure, thereby the original five spare and accessory parts are reduced to three spare and accessory parts, and the same function is achieved, the number of the spare and accessory parts of the coffee press filter is minimized, a production cost may be reduced, delivery packaging efficiency of the coffee press filter is improved, user assembly is faster and more convenient in use, and cleaning is easier after use.

### BRIEF DESCRIPTION OF THE DRAWINGS

FIG. 1 is a cross-sectional structure schematic diagram of the disclosure.

FIG. 2 is a cross-sectional exploded schematic diagram of the disclosure.

FIG. 3 is a local amplified structure schematic diagram of a filter pressing cylinder body of the disclosure.

FIG. 4 is a cross-sectional structure schematic diagram of a filter pressing bracket of the disclosure.

FIG. 5 is an exploded structure schematic diagram of a filtering cup of the disclosure.

FIG. 6 is an exploded structure schematic diagram of the filter pressing cylinder body and the filter pressing bracket of the disclosure.

FIG. 7 is a structure schematic diagram I of the filtering cup of the disclosure.

FIG. 8 is a structure schematic diagram II of the filtering cup of the disclosure.

FIG. 9 is a structure schematic diagram III of the filtering cup of the disclosure.

### DETAILED DESCRIPTION OF THE EMBODIMENTS

The disclosure is further described below with reference to drawings and embodiments.

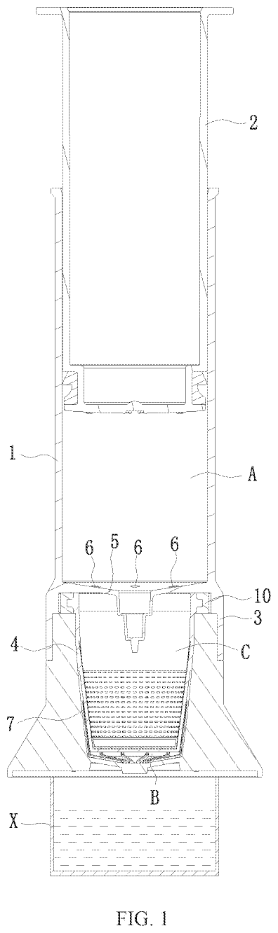

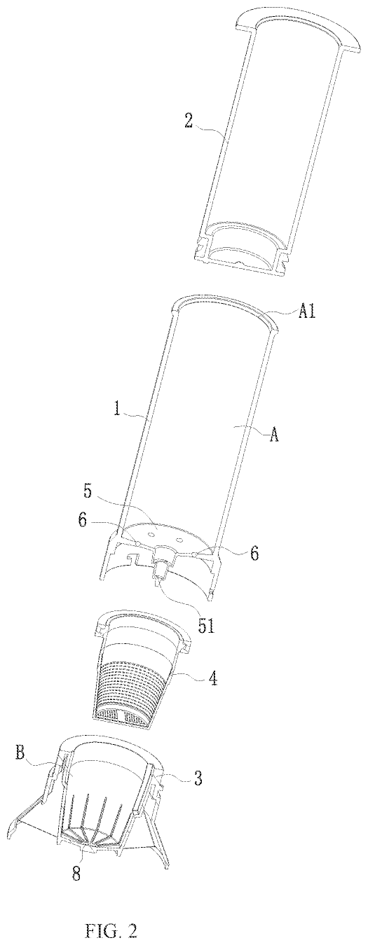

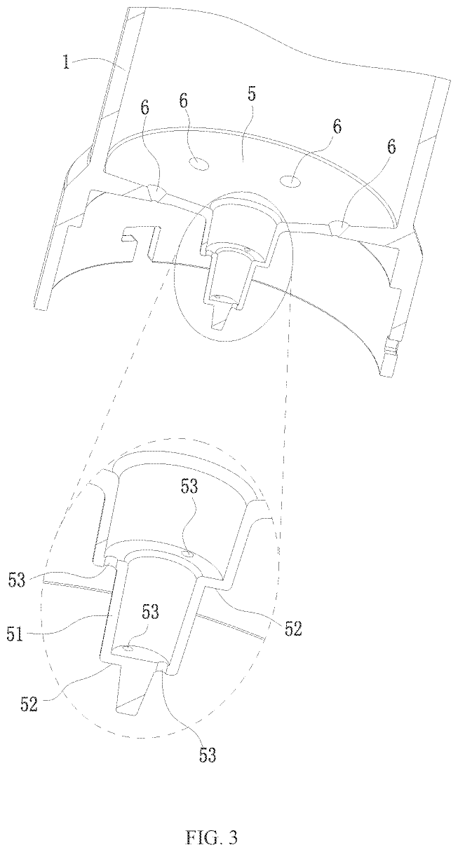

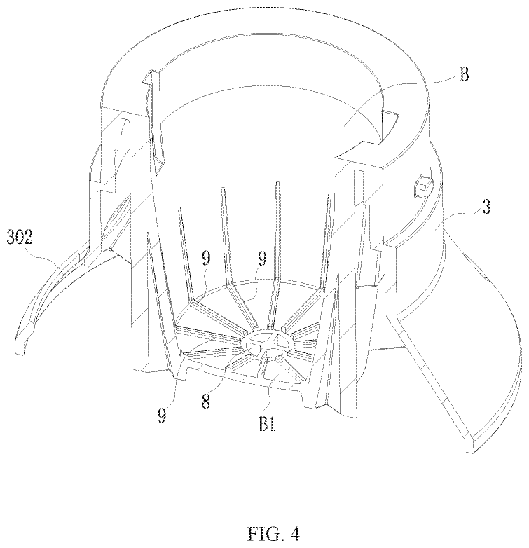

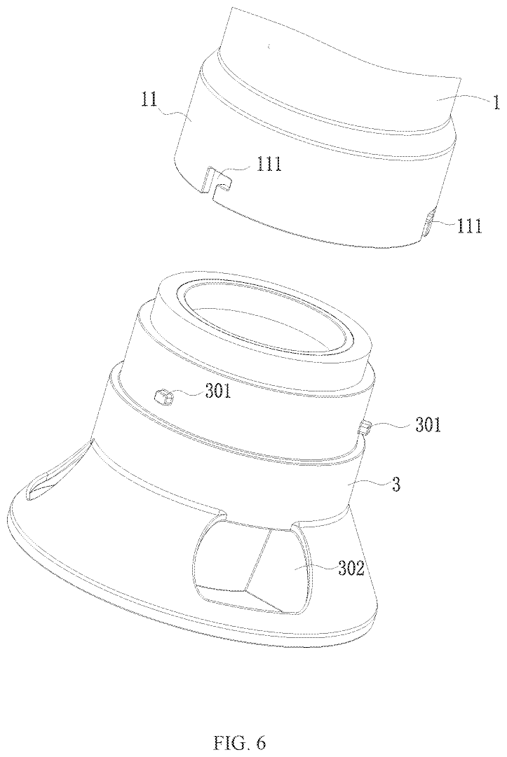

Referring to FIG. 1 to FIG. 6: the coffee press filter includes a filter pressing cylinder body 1, a filter pressing push rod 2 and a filter pressing bracket 3 detachably connected with the filter pressing cylinder body 1, the filter pressing cylinder body 1 is provided with a tubular water injection cavity A, one end of the water injection cavity A is an open end A1, and the filter pressing push rod 2 is pushed into the water injection cavity A through the open end A1 and is slid in a reciprocating type, the filter pressing bracket 3 is internally provided with an accommodating cavity B, the accommodating cavity B is internally provided with a filtering cup 4, the other end, opposite to the open end, of the water injection cavity A is integrally provided with a pressing cover 5, the pressing cover 5 is enclosed with the filtering cup 4 to form a brewing cavity C, and the pressing cover 5 is provided with a plurality of water outlets 6 communicated with the brewing cavity C and the water injection cavity A.

An integrated-type connection is formed by the filtering cup 4 and the filter pressing bracket 3.

The coffee press filter is integrally combined by this structure, thereby the original five spare and accessory parts are reduced to three spare and accessory parts, and the same function is achieved, the number of the spare and accessory parts of the coffee press filter is minimized, a production cost may be reduced, delivery packaging efficiency of the coffee press filter is improved, user assembly is faster and more convenient in use, and cleaning is easier after use.

The integrated-type connection specifically includes the following implementation modes.

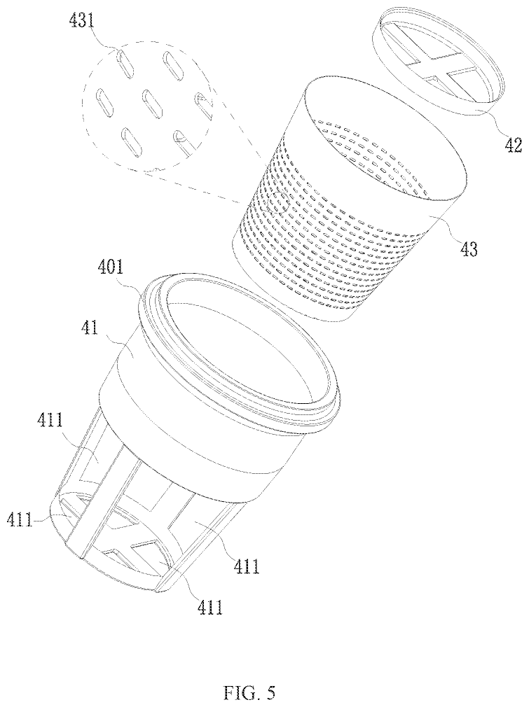

Implementation mode I: as shown in FIG. 5, the filtering cup 4 includes a cup body 41, a metal filter cover 43 and a pressing sleeve inner frame 42, a side wall and/or a bottom portion of the cup body 41 is provided with a plurality of liquid discharge openings 411, the metal filter cover 43 is installed in a cavity of the cup body 41 and covers the liquid discharge openings 411, the metal filter cover 43 is provided with multiple filtering small holes 431 communicated with the brewing cavity C, and the pressing sleeve inner frame 42 is installed at a bottom portion of the metal filter cover 43, and the reuse of the filtering cup 4 is achieved by cleaning through the metal filter cover 43; and in a production process, the cup body 41, the metal filter cover 43 and the pressing sleeve inner frame 42 may be integrally formed by injection molding or laser welding, certainly, it is not excluded that the three parties may also form a detachable connection, and it is convenient for completely cleaning after use, a shape of a bottom portion of the metal filter cover 43 may be consolidated by the pressing sleeve inner frame 42, and the metal filter cover 43 is prevented from being deformed and damaged.

In the implementation mode I, a liquid outlet clearance 7 is installed between the filtering cup 4 and an inner wall of the accommodating cavity B, and a bottom portion of the accommodating cavity B is provided with a liquid outlet 8 communicated with the liquid outlet clearance 7, after hot water is adequately mixed with coffee powder in the brewing cavity, coffee solution is obtained, and the coffee solution may be concentrated and discharged to the liquid outlet 8 after being flowed into the liquid outlet clearance 7.

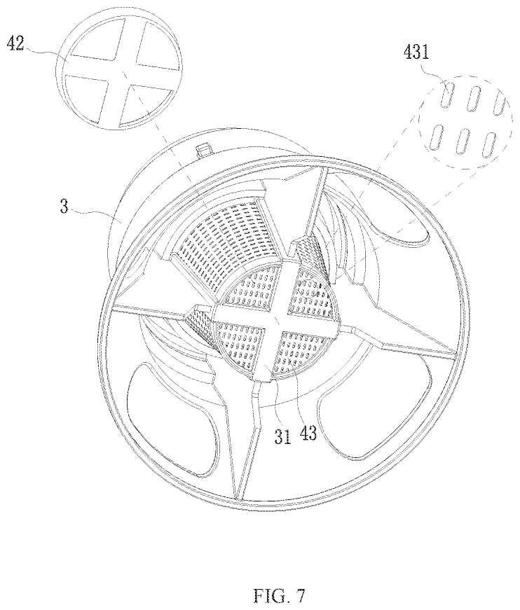

Implementation mode II: as shown in FIG. 7, the filtering cup 4 includes a metal filter cover 43, a side wall and a bottom wall of the metal filter cover 43 are provided with multiple filtering small holes 431, an upper end portion of the metal filter cover 43 and a filter pressing bracket 3 form an integrated structure through injection molding, and a lower end portion, provided with the filtering small holes 431, of the metal filter cover 43 is exposed below the filter pressing bracket 3, a support frame 31 for supporting an outer end face of the metal filter cover 43 is further formed on the filter pressing bracket 3 through the injection molding, and a pressing sleeve inner frame 42 may also be placed at a bottom portion of a cavity of the metal filter cover 43, and used for consolidating a shape of the bottom portion of the metal filter cover 43; and based on the filtering cup 4 in this structure, while coffee solution is discharged from the filtering small holes 431, it is directly downwards flowed into a liquid loading vessel X along the outer end face of the metal filter cover 43.

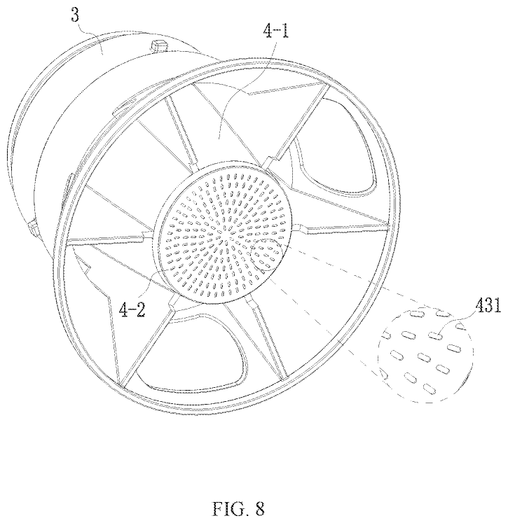

Implementation mode III: as shown in FIG. 8, the filtering cup 4 includes a plastic cup body 4-1 integrally formed with a filter pressing bracket 3 through injection molding, a bottom portion of the plastic cup body 4-1 is provided with a lower opening, the lower opening is connected with a metal filtering bottom cover 4-2, the metal filtering bottom cover 4-2 is provided with filtering small holes 431, and the metal filtering bottom cover 4-2 may be integrally formed with the plastic cup body 4-1 through the injection molding.

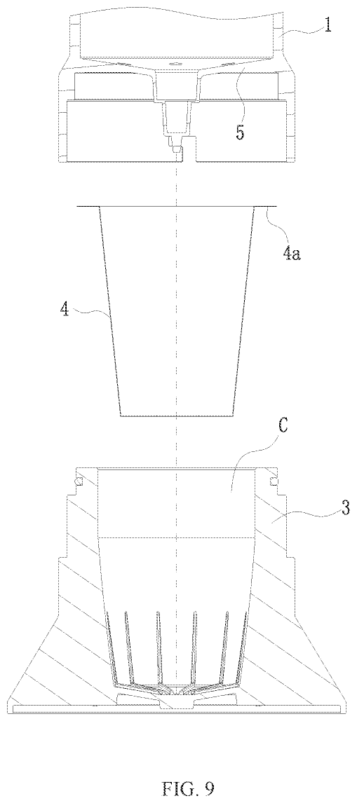

In addition, as shown in FIG. 9, the filtering cup 4 is made of a common coffee filter paper material, and a flange 4a is outwards extended from a rim of the cup. While the filter pressing cylinder body 1 is connected with the filter pressing bracket 3, the flange 4a is crimping-connected between a pressing cover 5 and the filter pressing bracket 3 for fixing, because the filtering cup in this structure is disposable, the filtering cup and the filter pressing bracket 3 are a detachable design, and it is convenient for replacing after use.

A cross sectional area of the water outlet 6 is gradually decreased in a direction from the water injection cavity A to the brewing cavity C.

In use, hot water is firstly poured into the water injection cavity A, and then the filter pressing push rod 2 is pushed into the water injection cavity A from the open end A1, the water outlets 6 in this structure are cooperated so that the hot water is discharged into the brewing cavity C of the filtering cup 4 in high pressure and high speed through the water outlets 6 and adequately mixed with coffee powder, after obtained coffee solution is discharged from the brewing cavity C, it is supplied for a user to drink.

The pressing cover 5 is integrally provided with a water injection column 51 downwards extended to a portion close to a bottom portion of the brewing cavity C, the water injection column 51 is a tower-type structure and has a plurality of layers of ring-shaped step surfaces 52, and a peripheral edge of each layer of the ring-shaped step surface 52 is provided with a plurality of central water outlets 53. While the coffee is made, more than one ring-shaped step surface 52 is inserted into the coffee powder along with the water injection column 51, a water injection structure of the filtering cup 4 in this structure is simple in design, the structure is rational, a brewing effect is good, and brewing efficiency is high.

A bottom surface B1 of the accommodating cavity B is slantwise installed from an external edge to a center, the liquid outlet 8 is installed in a central position of the bottom surface B1, multiple radially extended flow guiding convex ribs 9 are uniformly distributed on the bottom surface Bl, and the flow guiding convex ribs 9 are uniformly distributed along a circumferential direction of the liquid outlet 8 and extended to the inner wall of the accommodating cavity B, the flow guiding convex ribs 9 are capable of enabling the coffee solution flowed out from the liquid outlet clearance 7 to be rapidly flowed to the liquid outlet 8, stay time is reduced to avoid silting and blocking, and liquid discharge efficiency is improved.

A bottom portion of the filter pressing cylinder body 1 is provided with a connecting sleeve 11 nested on the filter pressing bracket 3, the connecting sleeve 11 is provided with an inverted L-type fastening groove 111, an outer wall of the filter pressing bracket 3 is provided with a fastening convex block 301 corresponding to the fastening groove 111, and the filter pressing cylinder body 1 is detachably connected with the filter pressing bracket 3 through fastening cooperation, the structure is simple, and installation and disassembly are convenient. After fastening, a top surface of the filtering cup 4 is pressed against the pressing cover 5 to form the brewing cavity C. In addition, after the filter pressing cylinder body 1 is connected with the filter pressing bracket 3, an outer end face of the connecting sleeve 11 is aligned to an outer end face of the filter pressing bracket 3.

An integrated fixed connection structure is formed by the filtering cup 4 and the filter pressing bracket 3 in modes of fastening, laser welding, integrated injection molding and bonding, the pressing cover 5 and the filter pressing cylinder body 1 are integrally formed by injection molding; and the integrated structure may be formed by the filtering cup 4 and the filter pressing bracket 3 in multiple modes.

A circle of positioning convex ribs 401 is extended on an outer end face, adjacent to a cup rim, of the filtering cup 4, the positioning convex ribs 401 are sheathed with a sealing ring 10, and the sealing ring 10 is sealingly pressed against a lower end face of the pressing cover 5, this structure is capable of sealing a clearance between the filtering cup 4 and the pressing cover 5, and preventing the brewing cavity C from generating leakage due to a high pressure.

As another implementation mode, the coffee press filter further includes a liquid loading vessel X, the coffee press filter is placed at an opening of the liquid loading vessel X, and the filter pressing bracket 3 is provided with at least one visible opening 302 for observing a liquid level height of the liquid loading vessel X; and because the coffee press filter may be placed at the opening of the liquid loading vessel X in use, while the liquid loading vessel X is not made of a transparent material, the coffee press filter may completely shield the only opening through which the liquid level height of the liquid loading vessel X may be observed, an amount of the extruded coffee solution is observed at any time by a user in a process of filter-pressing the coffee through the visible opening 302, and a full leakage situation of the coffee solution in the liquid loading vessel X is prevented from occurring.

In addition, structures of the filter pressing push rod 2, the filter pressing bracket 3 and the visible opening 302 belong to the prior art, so it is not described in detail here, referring to a previous application, with an application number or a patent number 202021091874X (Title: Reusable coffee press filter), of the applicant for details, the structures, applications and principles of the filter pressing push rod 2, the filter pressing bracket 3 and the visible opening 302 are disclosed.

The above are preferred schemes of the disclosure, which show and describe basic principles, main features and advantages of the disclosure. It should be understood by those skilled in the art that the disclosure is not limited to the above embodiments, the above embodiments and descriptions in the description only describe the principles of the disclosure, various changes and improvements may also be made to the disclosure under a precondition without departing from spirit and scope of the disclosure, these changes and improvements shall fall within the scope of the disclosure required for protection, and the scope of protection required by the disclosure is defined by appended claims and equivalents thereof.

What is claimed is:

1. A coffee press filter, comprising a filter pressing cylinder body (1), a filter pressing push rod (2) and a filter pressing bracket (3) detachably connected with the filter pressing cylinder body (1), wherein the filter pressing cylinder body (1) is provided with a tubular water injection cavity (A), one end of the water injection cavity (A) is an open end (A1), and the filter pressing push rod (2) is pushed into the water injection cavity (A) through the open end (A1) and is slid in a reciprocating type, wherein the filter pressing bracket (3) is internally provided with an accommodating cavity (B), the accommodating cavity (B) is internally provided with a filtering cup (4), the other end, opposite to the open end (A1), of the water injection cavity (A) is integrally provided with a pressing cover (5), the pressing cover (5) is enclosed with the filtering cup (4) to form a brewing cavity (C), and the pressing cover (5) is provided with a plurality of water outlets (6) communicated with the brewing cavity (C) and the water injection cavity (A).

2. The coffee press filter as claimed in claim 1, wherein an integrated-type connection is formed by the filtering cup (4) and the filter pressing bracket (3).

3. The coffee press filter as claimed in claim 1, wherein a cross sectional area of the water outlet (6) is gradually decreased in a direction from the water injection cavity (A) to the brewing cavity (C).

4. The coffee press filter as claimed in claim 1, wherein the pressing cover (5) is integrally provided with a water injection column (51) downwards extended to a portion close to a bottom portion of the brewing cavity (C), the water injection column (51) is a tower-type structure and has a plurality of layers of ring-shaped step surfaces (52), and a peripheral edge of each layer of the ring-shaped step surface (52) is provided with a plurality of central water outlets (53).

5. The coffee press filter as claimed in claim 1, wherein a liquid outlet clearance (7) is installed between the filtering cup (4) and an inner wall of the accommodating cavity (B), and a bottom portion of the accommodating cavity (B) is provided with a liquid outlet (8) communicated with the liquid outlet clearance (7).

6. The coffee press filter as claimed in claim 5, wherein a bottom surface (B1) of the accommodating cavity (B) is slantwise installed from an external edge to a center, the liquid outlet (8) is installed in a central position of the bottom surface (B1), multiple radially extended flow guiding convex ribs (9) are uniformly distributed on the bottom surface (B1), and the flow guiding convex ribs (9) are uniformly distributed along a circumferential direction of the liquid outlet (8) and extended to the inner wall of the accommodating cavity (B).

7. The coffee press filter as claimed in claim 1, wherein the filtering cup (4) comprises a cup body (41), a metal filter cover (43) and a pressing sleeve inner frame (42), a side wall and/or a bottom portion of the cup body (41) is provided with a plurality of liquid discharge openings (411), the metal filter cover (43) is installed in a cavity of the cup body (41) and covers the liquid discharge openings (411), the metal filter cover (43) is provided with multiple filtering small holes (431) communicated with the brewing cavity (C), and the pressing sleeve inner frame (42) is installed at a bottom portion of the metal filter cover (43).

8. The coffee press filter as claimed in claim 1, wherein a bottom portion of the filter pressing cylinder body (1) is provided with a connecting sleeve (11) nested on the filter pressing bracket (3), the connecting sleeve (11) is provided with an inverted L-type fastening groove (111), an outer wall of the filter pressing bracket (3) is provided with a fastening convex block (301) corresponding to the fastening groove (111), and the filter pressing cylinder body (1) is detachably connected with the filter pressing bracket (3) through fastening cooperation.

9. The coffee press filter as claimed in claim 2, wherein an integrated fixed connection structure is formed by the filtering cup (4) and the filter pressing bracket (3) in modes of fastening, laser welding, integrated injection molding and bonding, the pressing cover (5) and the filter pressing cylinder body (1) are integrally formed by injection molding.

10. The coffee press filter as claimed in claim 1, wherein a circle of positioning convex ribs (401) is extended on an outer end face, adjacent to a cup rim, of the filtering cup (4), the positioning convex ribs (401) are sheathed with a sealing ring (10), and the sealing ring (10) is sealingly pressed against a lower end face of the pressing cover (5).
